(19) United States
(12) Patent Application Publication
(10) Pub. No.: US 2012/0051173 A1
(43) Pub. Date: Mar. 1, 2012

(54) PAINT CAN SCRAPING DEVICE

(76) Inventor: DAN GALLOWAY, Victoria (CA)

(21) Appl. No.: 13/214,138

(22) Filed: Aug. 19, 2011

Related U.S. Application Data
(60) Provisional application No. 61/379,260, filed on Sep. 1, 2010.

(51) Int. Cl. B01F 13/00; A47L 17/06

(52) U.S. Cl. 366/129; 15/236.07

(57) ABSTRACT

A paint can scraping device comprises a flat single piece body having a front surface and a back surface for receiving advertising. The body includes a top end that has a pair of narrow-based lobes on each side of the top end and a broad-based lobe disposed between the two narrow-based lobes. The lobes are designed to scrape paint from the contoured surfaces of a paint can and particularly from the underside of the rim of the paint can. The body can be made from environmentally benign materials such as compostable plastic. The invention has a number of features which permits it to effectively clean a paint can and recover most of the paint left in a paint can that would otherwise be discarded.

### CROSS-REFERENCE TO RELATED APPLICATIONS

This application claims the benefit of U.S. Provisional Patent Application No. 61/379,260 filed on Sep. 1, 2010.

### BACKGROUND OF THE INVENTION

### Federal Sponsorship

N/A.

### FIELD OF THE INVENTION

This invention relates to apparatus for stirring paint in paint cans and cleaning residual paint from paint cans and more particularly to a paint can scraping device.

### BACKGROUND DISCUSSION

In home and commercial painting operations there is often a significant amount of residual paint left in the paint can. Because of the viscosity of the paint, it can adhere thickly to the sides of the can and the bottom of the can. Even when the can is up-ended to pour and drip paint from the can, a significant amount of paint can remain in the can. Disposing of the can with this paint remaining not only represents a waste of material but presents ecological contamination risks. There are a number of paint stir sticks available such as the wooden ruler-type of stick which is often given away at no cost when purchasing paint. These sticks are useful to stir paint in the can but are of limited use when attempting to remove the paint from the can. As well, the wooden stir sticks are relatively expensive to manufacture and constitute a waste of biomass. Such stir sticks take a long time to degrade in landfills. Other types of stir sticks have a blade-type device to scrape paint from the sides of the can. These types of devices are generally of molded polymer and are expensive to purchase for such a mundane and simple task. Furthermore, these devices tend to be incapable of removing paint from the upper inside rim of the can.

Therefore there is a requirement to provide a paint can scraping device that is simple to use, inexpensive to make and purchase and is well suited to removing paint from all interior surfaces of a paint can.

### SUMMARY OF THE INVENTION

To overcome deficiencies noted above the invention provided is a paint can scraping device made from an inexpensive flexible material comprised of one of recycled material, biodegradable material and compostable plastics. The device is designed to be fixed to the end of a typical paint stirring stick and therefore it is very inexpensive to make and purchase. The device can be purchased separately in singles and in packages of many. Since paint stirring sticks are generally given away, the paint purchaser need only purchase the inexpensive scraping device and fix one to the end of a paint stir stick. The device can also be used as a substrate for advertising and so it is advantageous for paint retailers to give the device away at no cost to consumers as is currently done with wooden stir sticks. The device can also be patterned to resemble a wood grain or any other desirable pattern

The device comprises a body comprising a single piece of compostable material. Either side of the body is well suited as an advertising substrate or substrate for other printed matter such as instructions or designs. The body has a spatula-like shape. The bottom end is horizontal and the two sides are angled out from each other at a slight angle. The bottom corners are curved. The top end of the body has curved sinusoidal shape having two narrow concave lobes on opposite corners of the top and a broader concave lobe in the middle of the top end. The central lobe has an aperture for hanging the device on a hook for display in a retail setting or for drying after use. The body further comprises two concave slits cut into the body. Each edge of the slits terminates in with an aperture so that material of the body does not tear. The slits split apart to receive a stir stick between them. Once the stir stick is placed through the two slits the device will be stable on the stir stick and remain in position while being used with a viscous paint liquid. The material of the device is sufficiently resilient to move through a viscous liquid without bending or collapsing. Once the device has performed its task it can be removed and cleaned for further use or it can be discarded.

The placement of the device onto a paint stir stick creates a paint stirring stick that is able to scrape paint from the inside of the can. The top end of the body has a central lobe that will bend to the contour of the can when scraping paint from the can. The sides of the device are angled outwards so that the body can reach the sides of the paint can without interference with the rim of the paint can. The top end of the body has two end lobes which are contoured for scraping paint from the inside rim of the paint can.

### BRIEF DESCRIPTION OF THE DRAWINGS

Embodiments of the invention are illustrated by way of example and not limitation in the figures of the accompanying drawings, in which like reference numerals indicate corresponding, analogous or similar elements, and in which:

FIG. 1 is front face view of one embodiment of the invention.

FIG. 2 is a back face view of one embodiment of the invention.

FIG. 3 is a front face view of one embodiment of the invention illustrating dimensions.

FIG. 4 is a front surface view of the device attached to the end of the paint stirring stick.

FIG. 5 is a back view of the device attached to the end of a paint stirring stick.

FIG. 6 is a first side view of the device attached to the end of a paint stirring stick.

FIG. 7 is a back perspective view of the device attached to the end of a paint stirring stick.

FIG. 8 is a top front perspective view of the device attached to the end of a paint stirring stick.

FIG. 9 is a view of the device attached to the end of a stirring stick and being used to scrape paint cleanly from the inside surface of a paint can.

It will be appreciated that for simplicity and clarity of illustration, elements shown in the figures have not necessarily been drawn to scale. For example, the dimensions of some of the elements may be exaggerated relative to other elements for clarity.

### DETAILED DESCRIPTION OF EMBODIMENTS OF THE INVENTION

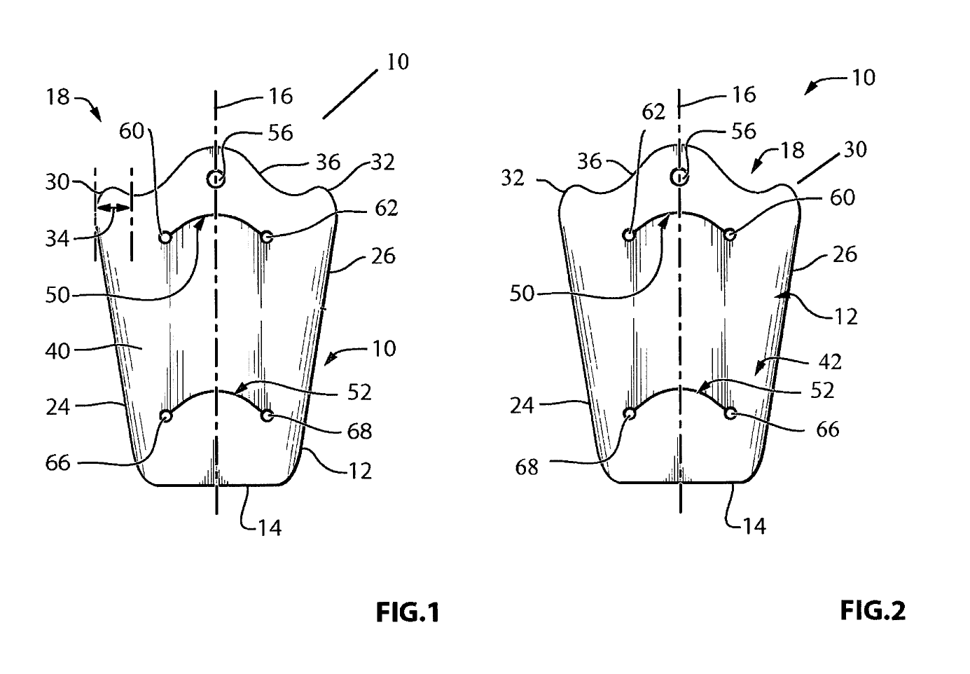

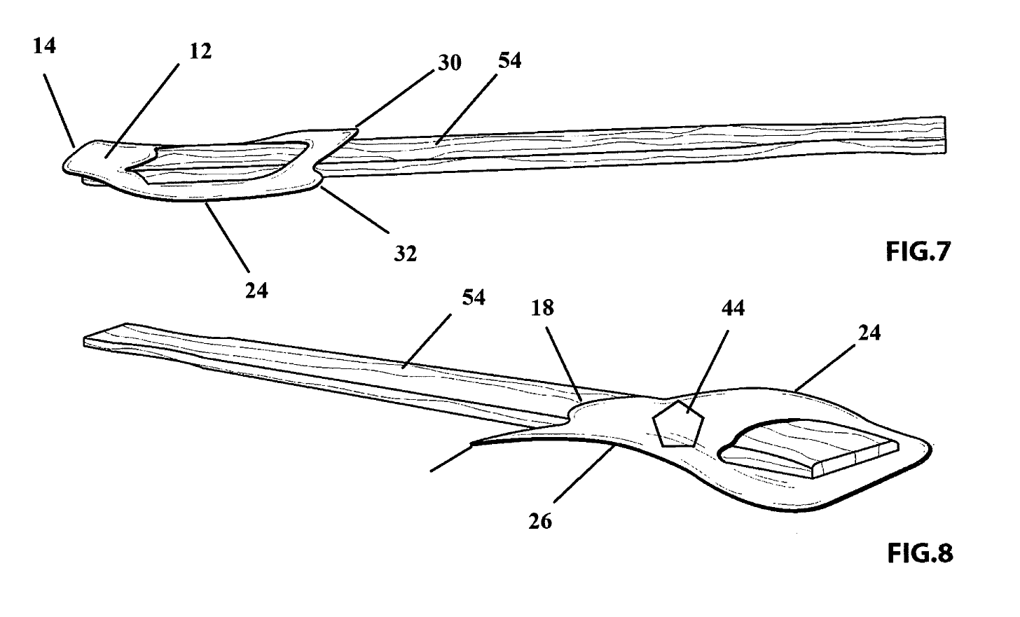

Referring now to FIGS. 1 to 10, there is shown a variety of views of the invention 10 comprising a single piece body 12.

Body 12 of the invention 10 has a horizontal bottom side 14. The left and right sides 24 and 26 of the body 12 are angled slightly away from centre axis 16 so that when the device is attached to a paint stir stick and inserted into a paint can for scraping the sides of the can the handle of the stir stick is not interfered with by the rim of the paint can.

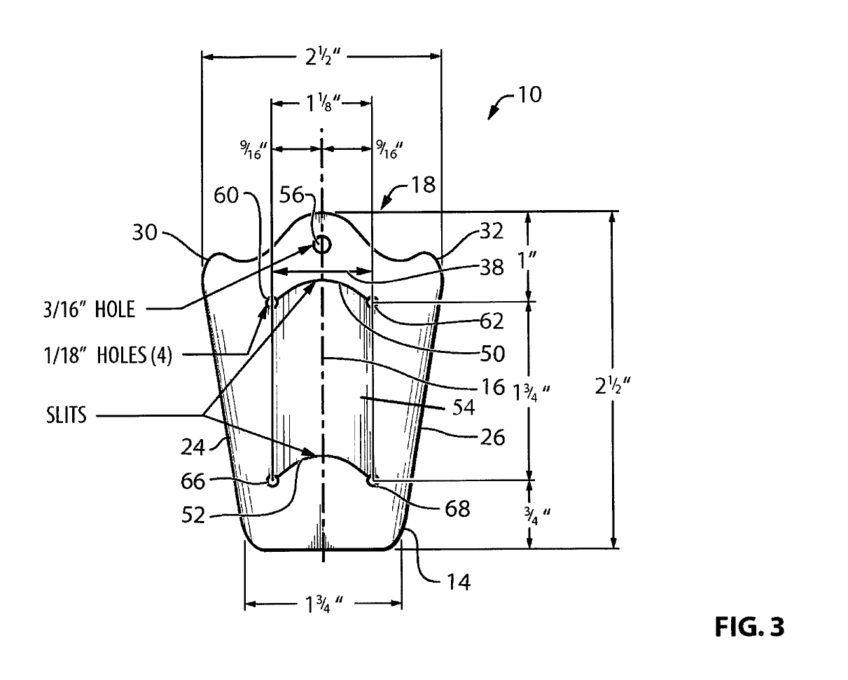

The top side 18 of the body 12 of the invention 10 has an outboard pair of concave lobes 30 and 32 having a relatively narrow width 34. The top side 18 has a central lobe 36 having relatively wide width 38 (See FIG. 3).

The body 12 further comprises a front surface 40 and a back surface 42. The front and back surfaces are suitable substrates for mounting advertising 44 as shown in FIG. 3.

Disposed within the centre of the body 12 are two slits 50 and 52. Slit 50 is disposed towards the top of the body and below the central lobe 36. Slit 52 is disposed towards the bottom of the body and equally across the centre line 16. The slits are concave in shape. Above top slit 50 and below the top surface 36 of central lobe 26 is an aperture 56 for hanging the body 12 on a hook. To prevent the material of the body 12 from tearing when a paint stir stick is inserted into the slits 50 and 52 each of the slits terminates in a pair of apertures: 60 and 62 for slit 50; and, 66 and 68 for slit 52. Typical dimensions for one embodiment of the invention and its elements are shown in FIG. 3.

Referring to FIG. 3 there is shown one embodiment of the invention 10 mounted to the end of a stir stick 54. Stir stick 54 is partially shown between slit 50 and slit 52. The handle of the stir stick is omitted for clarity.

The body is preferably made from a biodegradable material such as a compostable plastic. However, in other embodiments of the invention the body may be made from a flexible material such as pressed paper, cardboard, or a resilient foam material. A stiffer polymer may also be used for a more permanent or longer lasting device. With the body is made to be disposable after a limited number of uses. Biodegradable material has ecological advantages.

The body can be pressed from larger stacked sheets of material that are adhered together along the bottom side so that individual body parts may be removed by a tear-away movement. The device can also be sold in packages or distributed gratuitously as individual pieces.

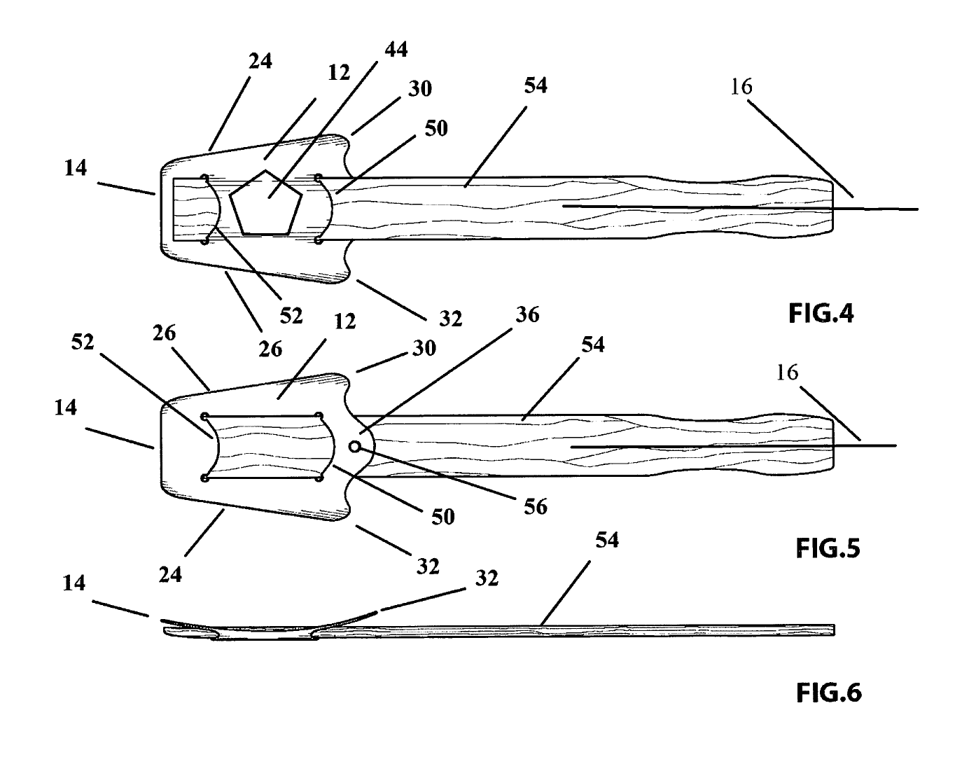

FIGS. 4 to 8 show the device attached to a stir stick on a variety of views. The following elements are illustrated:

12 body of the invention

14 bottom side of the body

16 axis

18 top side of the body

24 left side of the body

26 right side of the body

30 left side top lobe

32 right side top lobe

36 top side large lobe

44 advertising

50 top slit

52 bottom slit

54 stir stick

56 aperture for hanging body

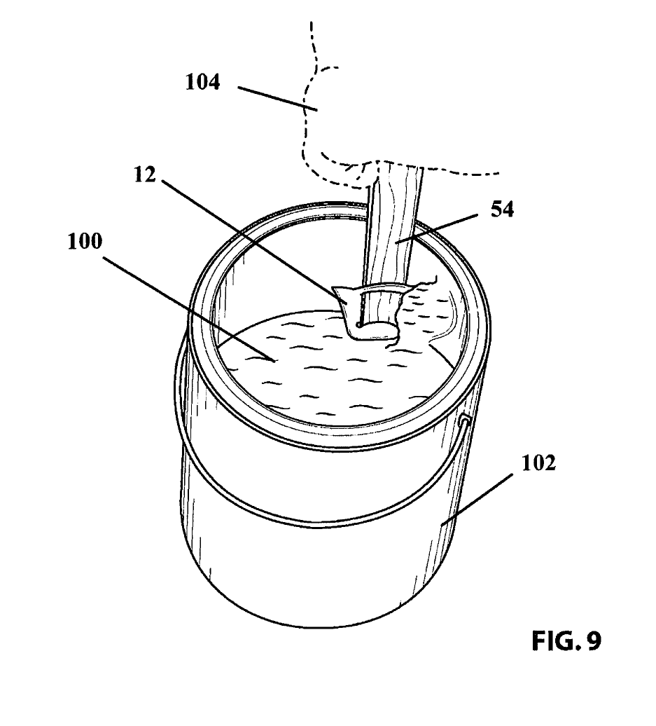

FIG. 9 shows the body 12 of the device being used to scrape paint 100 from the inside surfaces of a paint can 102. Stir stick 54 is shown grasped by a hand 104.

The cleaned paint can is now ready for recycling or disposal and presents a much less threat to the environment.

What is claimed is:

1. A paint can scraping device comprising a body having an axis, a top side, a bottom side, a left side and a right side, a front surface and a rear surface, wherein, said bottom side is horizontal; said left side and said right side are angled slightly away from said axis; said top side comprises a first and a second narrow-based concave lobe on opposite ends of the top side and a broad-based concave lobe disposed in the center of the top side between said first and said second narrow-based lobes.

2. The device of claim 1 further comprises a first concave-shaped slit and a second concave-shaped slit for receiving a stir stick.

3. The device of claim 2 wherein said first concave-shaped slit and said second concave-shaped slit have opposite ends terminating in apertures.

4. The device of claim 3 wherein said front surface and said rear surface are suitable as a substrate for printed material.

5. The device of claim 1 wherein said body a made from a biodegradable plastic.

6. In combination, a paint can scraping device and a paint stir stick, wherein said paint can scraping device comprises a body having a first concave slit disposed near the top end of the body and a second concave slit disposed near the bottom end of the body, wherein said first concave slit and said second concave slit are adapted for receiving said paint stir stick.
